(19) United States
(12) Patent Application Publication
(10) Pub. No.: US 2025/0066968 A1
(43) Pub. Date: Feb. 27, 2025

(54) METHOD FOR DEGUMMING AND DECOLORIZING POLYESTER FABRIC

(71) Applicant: NAN YA PLASTICS CORPORATION, TAIPEI (TW)

(72) Inventors: Te-Chao Liao, TAIPEI (TW); Jung-Jen Chuang, TAIPEI (TW); Chung-Chi Su, TAIPEI (TW)

(73) Assignee: NAN YA PLASTICS CORPORATION, TAIPEI (TW)

(21) Appl. No.: 18/472,250

(22) Filed: Sep. 22, 2023

(30) Foreign Application Priority Data
Aug. 23, 2023 (TW) 112131603

(51) Int. Cl. D06B 3/10; D06P 5/13

(52) U.S. Cl. CPC D06B 3/10; D06P 5/135; D10B 2331/04

(57) ABSTRACT

A method for degumming and decolorizing polyester fabrics is provided. The method includes the following steps. A first polyester fabric attached with a dye and a gum-film or treatment agent is provided. The gum-film or treatment agent in the first polyester fabric is stripped through a combined formulation of an alkaline aqueous solution and a catalyst to obtain a second polyester fabric. Then, the second polyester fabric is decolorized by a combination of a chemical reduction method and a chemical oxidation method to obtain a third polyester fabric.

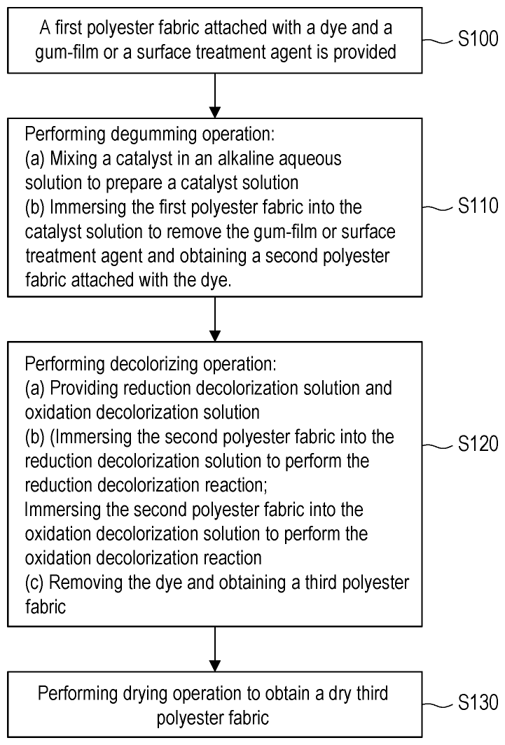

### CROSS-REFERENCE TO RELATED APPLICATION

This application claims the priority benefit of Taiwan application serial no. 112131603filed on Aug. 23, 2023. The entirety of the above-mentioned patent application is hereby incorporated by reference herein and made a part of this specification.

### BACKGROUND

### Technical Field

The disclosure relates to a decolorization method, and in particular relates to a method for degumming and decolorizing polyester fabric.

### Description of Related Art

Generally, dyed polyester fabrics have a dye and at least one of a surface treatment agent and a gum-film. The gum-film may be, for example, polyurethane (PU) gum, polymethyl methacrylate (PMMA, acrylic) gum, polyurethane (PU) film, thermoplastic polyurethane (TPU) film, or thermoplastic polyether ester elastomer (TPEE) film, etc. The surface treatment agent may be, for example, a water-repellent agent or the like. For recycled polyester fabrics, the dyes, surface treatment agents and gum-films attached to the recycled polyester fabrics need to be removed.

Currently known methods for decolorizing polyester fabrics include solvent extraction and chemical bleaching. For the solvent extraction method, for example, please refer to Taiwan Disclosure Patent Publication No. 1481762, which uses solvent vapor to extract dyes that color polyester fibers. For chemical bleaching methods, for example, please refer to U.S. Pat. No. 5,261,925A1, which decolorizes polyester fabrics through ozone oxidation reaction, and U.S. Pat. No. 7,981,337B2, which decolorizes polyester fabrics through reduction reaction. However, the above decolorization methods usually only remove the dye, but cannot remove the surface treatment agent or gum-film. Furthermore, when the surface treatment agent and/or gum-film on the dyed polyester fabric is not removed, subsequent dye removal may be difficult.

Therefore, developing a method that may effectively remove dyes, surface treatment agents and gum-films attached to polyester fabrics is an important goal in this field.

### SUMMARY

A method for degumming and decolorizing polyester fabrics, which may effectively remove surface treatment agents, gum-films and dyes attached to polyester fabrics, are provided in the disclosure.

The method for degumming and decolorizing a polyester fabric of the disclosure includes providing a first polyester fabric attached with a dye and a gum-film or a surface treatment agent, and performing degumming and decolorizing operations in sequence. The degumming operation includes the following operation. A catalyst is mixed in a first alkaline aqueous solution to prepare a catalyst solution. The first polyester fabric is immersed into the catalyst solution to remove the gum-film or the surface treatment agent and a second polyester fabric attached with the dye is obtained. The decolorizing operation includes the following operation. A reduction decolorization solution and an oxidation decolorization solution are provided. The second polyester fabric is immersed into the reduction decolorization solution for the reduction decolorization reaction. The second polyester fabric is immersed into the oxidation decolorization solution for the oxidation decolorization reaction, and a third polyester fabric is obtained.

In an embodiment of the disclosure, the gum-film is selected from at least one of PU gum-film, TPU gum-film, TPEE gum-film and acrylic gum, and the surface treatment agent is selected from at least one of a fluorine-containing water-repellent agent and a fluorine-free water-repellent agent.

In an embodiment of the disclosure, the alkaline aqueous solution includes at least one selected from an alkali metal hydroxide solution, an alkaline earth metal hydroxide solution, an alkaline earth metal carbonate solution, and an alkaline earth metal bicarbonate solution.

In an embodiment of the disclosure, the catalyst includes at least one selected from a quaternary ammonium salt, a quaternary ammonium base, a quaternary phosphonium salt, and a crown ether.

In an embodiment of the disclosure, the quaternary ammonium salt includes at least one selected from benzyltributylammonium chloride, benzyltriethylammonium chloride, tetrabutylammonium bromide, tetrabutylammonium chloride, tetrabutylammonium hydrogen sulfate, tricaprylmethylammonium chloride, dodecyltrimethylammonium chloride, tetradecyl, and trimethylammonium chloride.

In an embodiment of the disclosure, the quaternary ammonium base includes at least one selected from phenyltrimethylammonium hydroxide, benzyltriethylammonium hydroxide, benzyltrimethylammonium hydroxide, triethylmethylammonium hydroxide, tetramethylammonium hydroxide, tetraethylammonium hydroxide, tetrapropylammonium hydroxide, and tetrabutylammonium hydroxide.

In an embodiment of the disclosure, the quaternary phosphonium salt includes at least one selected from butyltriphenylphosphonium bromide, ethyltriphenylphosphonium acetate, ethyltriphenylphosphonium iodide, ethyltriphenylphosphonium bromide, and benzyltriphenylphosphonium chloride.

In an embodiment of the disclosure, the crown ether includes at least one selected from 12-crown-4, 15-crown-5, 18-crown-6, dibenzo-18-crown-6, and diaza-18-crown-6.

In an embodiment of the disclosure, a concentration of the catalyst solution is 0.5 to 20 g/L, and a weight ratio of the catalyst solution to the first polyester fabric is 5:1 to 50:1.

In an embodiment of the disclosure, a reaction condition for removing the gum-film or the surface treatment agent is: a reaction temperature of 60 to 140° C., and a reaction time of 5 to 60 minutes.

In an embodiment of the disclosure, the reduction decolorization solution includes a reducing agent and water, and the reducing agent is at least one selected from ammonium dodecylpoly (oxyethylene) sulfate, sodium dithionite, sodium thiosulfate, sodium hydroxymethanesulfinate, and thiourea dioxide.

In an embodiment of the disclosure, a concentration of the reduction decolorization solution is 0.5 to 15 g/L, and a weight ratio of the reduction decolorization solution to the second polyester fabric is 5:1 to 50:1.

In an embodiment of the disclosure, a condition for the reduction decolorization reaction is: a reaction temperature is 90 to 140° C., and a reaction time is 5 to 60 minutes.

In an embodiment of the disclosure, the oxidation decolorization solution includes an oxidant and water, and the oxidant is at least one selected from hydrogen peroxide, sodium nitrate, sodium nitrite, chlorite, hypochlorite, ammonium persulfate, and sodium persulfate.

In an embodiment of the disclosure, a concentration of the oxidation decolorization solution is 0.5 to 15 g/L, and a weight ratio of the oxidation decolorization solution to the second polyester fabric is 5:1 to 50:1.

In an embodiment of the disclosure, a condition for the oxidation decolorization reaction is: a reaction temperature is 60 to 120° C., and a reaction time is 5 to 60 minutes.

In an embodiment of the disclosure, a sequence of the decolorizing operation is: the reduction decolorization reaction is performed firstly on the second polyester fabric, and then the oxidation decolorization reaction is performed on the second polyester fabric that has undergone the reduction decolorization reaction.

In an embodiment of the disclosure, a sequence of the decolorizing operation is: the oxidation decolorization reaction is performed firstly on the second polyester fabric, and then the reduction decolorization reaction is performed on the second polyester fabric that has undergone the oxidation decolorization reaction.

In an embodiment of the disclosure, the method for degumming and decolorizing further includes performing a drying operation on the third polyester fabric. A condition for the drying operation is: a drying temperature is 120° C., and a drying time is 2 to 4 hours.

Based on the above, in the method for degumming and decolorizing of polyester fabric of the disclosure, after stripping various types of surface treatment agents or gum-films on the surface of a polyester fabric by using a combined formulation of an alkaline aqueous solution and a catalyst, then the polyester fabric is decolorized by a combination of a chemical reduction method and a chemical oxidation method. In this way, the surface treatment agent or gum-film and the dye on the polyester fabric material may be effectively removed. In addition, compared with the solvent extraction method using organic solvents, the disclosure performs gum removal and decolorization on the polyester fabric through an aqueous solution (i.e., aqueous catalyst solution, reduction decolorization solution, oxidation decolorization solution), which is obviously more environmentally friendly.

### BRIEF DESCRIPTION OF THE DRAWINGS

FIGURE is a flowchart of a method for degumming and decolorizing a polyester fabric of the disclosure.

### DETAILED DESCRIPTION OF DISCLOSED EMBODIMENTS

Hereinafter, embodiments of the disclosure are described in detail. However, these embodiments are illustrative, and the disclosure is not limited thereto.

Herein, the range indicated by “one numerical value to another numerical value” is a general representation which avoids enumerating all numerical values in the stated range one by one in the specification. Thus, the recitation of a particular numerical range encompasses an arbitrary numerical value within that numerical range, as well as smaller numerical ranges bounded by the arbitrary numerical value within that numerical range, as if the arbitrary numerical value and the smaller numerical range were expressly written in the specification.

It should be understood that, although terms such as “first”, “second”, and “third” may be used herein to describe various elements or signals, these elements or signals should not be limited by these terms. These terms are primarily used to distinguish one element from another element or one signal from another signal. In addition, the term “or” used herein should, depending on the actual situation, include any one or a combination of the associated listed items.

FIGURE is a flowchart of a method for degumming and decolorizing a polyester fabric of the disclosure. Referring to FIGURE, step S100 is executed: a first polyester fabric attached with a dye and a gum-film or a surface treatment agent is provided. Specifically, polyester fabric generally refers to objects woven from polyester fiber, such as clothing, bags, bed sheets, etc. Polyester fiber is a man-made fiber and may include (but is not limited to) polyethylene terephthalate (PET) fiber, polybutylene terephthalate (PBT) fiber, polytrimethylene terephthalate (PTT) fiber, poly (1,4-cyclohexanedimethylene terephthalate) (PCT) fiber, and poly (ethylene naphthalene-2,6-dicarboxylate) (PEN) fiber. There are no particular limitations on the type of polyester fiber in this disclosure.

In this embodiment, the dyes may be, for example, disperse dyes, but not limited thereto. In some embodiments, the gum-film may be, for example, a fluorine-containing water-repellent agent (e.g., perfluorooctanoic acid and its salts, perfluorooctanesulfonyl compounds, alkylphenol polyoxyethylene ethers, perfluoroethanesulfonyl compounds, or sulfonic acid salt), fluorine-free water-repellent agents (e.g., organic silicon water-repellent agents and long-chain hydrocarbon water repellents, products such as 3M PM-3705, PM-3888, Ruco-dry ECO Plus, etc.) or a combination thereof, but not limited thereto. The gum-film may be, for example, polyurethane gum-film, thermoplastic polyurethane film, thermoplastic polyether ester elastomer gum-film, polymethyl methacrylate (acrylic) gum, or a combination thereof, but not limited thereto.

Next, step S110 is executed: a degumming operation is performed on the first polyester fabric. The degumming operation includes the following operation. Firstly, a catalyst is mixed in an alkaline aqueous solution to prepare a catalyst solution. Next, the first polyester fabric is immersed into the catalyst solution to remove the gum-film or the surface treatment agent and a second polyester fabric attached with the dye is obtained. Herein, the second polyester fabric refers to the polyester fabric after the degumming operation. That is, the second polyester fabric has dye attached to it, but no gum-film and surface treatment agent are attached, or only a trace amount of gum-film and/or a trace amount of surface treatment agent is attached. Specifically, at this stage, the surface treatment agent and gum-film on the polyester fabric material are removed through the mixed formulation of a catalyst and an alkaline aqueous solution.

In the disclosure, the catalyst may be, for example, at least one of a quaternary ammonium salt, a quaternary ammonium base, a quaternary phosphonium salt, and a crown ether. In some embodiments, the quaternary ammonium salt may include (but is not limited to) at least one selected from benzyltributylammonium chloride, benzyltriethylammonium chloride, tetrabutylammonium bromide, tetrabutylammonium chloride, tetrabutylammonium hydrogen sulfate, tricaprylmethylammonium chloride, dodecyltrimethylammonium chloride, tetradecyl, and trimethylammonium chloride. In some embodiments, the quaternary ammonium base may include (but is not limited to) at least one selected from phenyltrimethylammonium hydroxide, benzyltriethylammonium hydroxide, benzyltrimethylammonium hydroxide, triethylmethylammonium hydroxide, tetramethylammonium hydroxide, tetraethylammonium hydroxide, tetrapropylammonium hydroxide, and tetrabutylammonium hydroxide. In some embodiments, the quaternary phosphonium salt may include (but is not limited to) at least one selected from butyltriphenylphosphonium bromide, ethyltriphenylphosphonium acetate, ethyltriphenylphosphonium iodide, ethyltriphenylphosphonium bromide, and benzyltriphenylphosphonium chloride. In some embodiments, the crown ether may include (but is not limited to) at least one selected from 12-crown-4, 15-crown-5, 18-crown-6, dibenzo-18-crown-6, and diaza-18-crown-6.

In the disclosure, the alkaline aqueous solution may be, for example, an alkali metal hydroxide solution, an alkaline earth metal hydroxide solution, an alkaline earth metal carbonate solution, an alkaline earth metal bicarbonate solution, or a combination thereof. In some embodiments, the alkali metal hydroxide may include (but is not limited to) at least one selected from sodium hydroxide (NaOH) and potassium hydroxide (KOH). In some embodiments, the alkaline earth metal hydroxide may include (but is not limited to) at least one selected from calcium hydroxide (Ca(OH)₂), barium hydroxide (Ba(OH)₂), and magnesium hydroxide (Mg(OH)₂). In some embodiments, the alkaline earth metal carbonate may include (but is not limited to) at least one selected from magnesium carbonate and calcium carbonate. In some embodiments, the alkaline earth metal bicarbonate may include (but is not limited to) at least one selected from magnesium bicarbonate and calcium bicarbonate. Here, since an alkaline aqueous solution serves as a solvent, environmental pollution caused by organic solvents may be avoided.

In some embodiments, the concentration of the catalyst in the catalyst solution may be, for example, 0.5 to 20 grams/liter (g/L), and preferably may be, for example, 2 to 10 g/L. In some embodiments, the bath ratio (weight ratio) of the catalyst solution to the first polyester fabric may be, for example, 5:1 to 50:1, preferably, for example, 8:1 to 20:1. In some embodiments, the reaction condition for removing the gum-film is: the reaction temperature may be, for example, 60 to 140° C., and the reaction time may be, for example, 5 to 60 minutes (min); preferably, the reaction temperature may be, for example, 100 to 130° C., and the reaction time may be, for example, 20 to 40 minutes. After completing the degumming operation, the second polyester fabric may be filtered and cleaned.

Next, step S120 is executed: a decolorizing operation is performed. The decolorizing operation includes at least the following operation. A reduction decolorization solution and an oxidation decolorization solution are provided. The second polyester fabric is immersed into the reduction decolorization solution for the reduction decolorization reaction. The second polyester fabric that has undergone the reduction decolorization reaction is immersed into the oxidation decolorization solution for the oxidation decolorization reaction, and a third polyester fabric is obtained by removing the dye. Herein, the third polyester fabric refers to the polyester fabric after undergoing the degumming operation and the dye removal operation. That is, the third polyester fabric has no dye or gum-film attached, or only a trace amount of gum-film and/or a trace amount of dye is attached. Specifically, at this stage, the dye on the polyester fabric material is removed through reduction decolorization reaction and oxidation decolorization reaction.

In the disclosure, the reduction decolorization solution is a reducing agent aqueous solution. In some embodiments, the reducing agent may include (but is not limited to) at least one selected from ammonium dodecylpoly (oxyethylene) sulfate, sodium dithionite, sodium thiosulfate, sodium hydroxymethanesulfinate, and thiourea dioxide. Here, since an aqueous solution serves as a solvent, environmental pollution caused by organic solvents may be avoided.

Specifically, the second polyester fabric after degumming is immersed in the eduction decolorization solution. The reducing agent may reduce the dye molecules, for example, the N═N double bond of the azo dye may be reduced to the NH2 single bond, thereby removing part of the dye (i.e., the dye removed through the reduction reaction). In some embodiments, the concentration of the reducing agent in the reduction decolorization solution may be, for example, 0.5 to 15 g/L, and preferably may be, for example, 2 to 10 g/L. In some embodiments, the bath ratio (weight ratio) of the reduction decolorization solution and the second polyester fabric may be, for example, 5:1 to 50:1, preferably, for example, 8:1 to 20:1. In some embodiments, the condition for the reduction decolorization reaction is: the reaction temperature may be, for example, 90 to 140° C., and the reaction time may be, for example, 5 to 60 minutes. Preferably, the reaction temperature may be, for example, 120 to 140° C., and the reaction time may be, for example, 20 to 40 minutes. When within the above-mentioned temperature range and time range, the reducing agent may have good reactivity and may effectively remove the dye from the polyester fabric.

In the disclosure, the oxidation decolorization solution is a combined formulation of oxidant and water. In some embodiments, the oxidant may include (but is not limited to) at least one selected from hydrogen peroxide, sodium nitrate, sodium nitrite, sodium chlorite, calcium chlorite, sodium hypochlorite, calcium hypochlorite, ammonium persulfate, and sodium persulfate. Here, since an aqueous solution serves as a solvent, environmental pollution caused by organic solvents may be avoided.

Specifically, the second polyester fabric after the reduction decolorization reaction is immersed in an oxidation decolorization solution, in which the oxidant oxidizes the dye and destroys the conjugated structure, thereby removing part of the dye (i.e., the dye removed through the oxidation reaction). In some embodiments, the concentration of the oxidant in the oxidation decolorization solution may be, for example, 0.5 to 15 g/L, and preferably may be, for example, 1 to 5 g/L. In some embodiments, the bath ratio (weight ratio) of the oxidation decolorization solution and the second polyester fabric may be, for example, 5:1 to 50:1, preferably, for example, 8:1 to 20:1. In some embodiments, the condition for the oxidation decolorization reaction is: the reaction temperature may be, for example, 60 to 120° C., and the reaction time may be, for example, 5 to 60 minutes. Preferably, the reaction temperature may be, for example, 70 to 100° C., and the reaction time may be, for example, 20 to 40 minutes. When within the above-mentioned temperature range and time range, the oxidant may have good reactivity and may remove the dye from the polyester fabric.

In the decolorizing operation, a reduction decolorization reaction may be performed firstly on the second polyester fabric, and then an oxidation decolorization reaction is performed. In other embodiments, an oxidation decolorization reaction may be performed firstly on the second polyester fabric, and then a reduction decolorization reaction is performed. The disclosure does not limit the order of the decolorization reactions. It is worth noting that in some cases, the decolorization effect of performing the reduction decolorization reaction first is better than the decolorization effect of performing the oxidation decolorization reaction first.

Next, step S130 is executed: a drying operation is performed on the third polyester fabric. In some embodiments, the condition for the drying operation is: the drying temperature may be, for example, 120° C., and the drying time may be, for example, 2 to 4 hours, but the disclosure is not limited thereto. At this point, the degumming and decolorizing the polyester fabric of the disclosure has been substantially completed.

Below, the actual effect of the method for degumming and decolorizing a polyester fabric of the disclosure is explained in detail through embodiments. However, the following embodiments are not intended to limit the disclosure.

### EMBODIMENT

### Examples 1 to 12

Examples 1 to 12 involve the following steps of degumming and decolorizing polyester fabric attached with gum-films or surface treating agents of different types of materials (as shown in Table 1) and a dye. Each step is briefly described below:

(1) Degumming Operation

A catalyst (as shown in Table 1) is mixed in a sodium hydroxide aqueous solution to prepare a catalyst aqueous solution with a concentration of 0.5 to 20 g/L. Then, 10 grams of polyester fabric is added for a degumming reaction, in which the bath ratio of the catalyst solution to the polyester fabric is 5:1 to 50:1, the reaction temperature is 60 to 140° C., and the reaction time is 5 to 60 minutes. Then, a filtering and draining step is performed on the polyester fabric that has undergone the degumming operation.

(2) Decolorizing Operation

Sodium dithionite is mixed with water to prepare a reduction decolorization solution with a concentration of 0.5 to 15 g/L. Next, the polyester fabric that has undergone the degumming operation is added for the reduction decolorization reaction, in which the reaction temperature is 90 to 140° C., and the reaction time is 5 to 60 minutes. Then, a filtering and draining step is performed on the polyester fabric that has undergone the degumming operation and the reduction decolorization reaction.

Next, an ammonium persulfate aqueous solution with a concentration of 0.5 to 15 g/L is added for the oxidation decolorization reaction, in which the reaction temperature is 60 to 120° C., and the reaction time is 5 to 60 minutes. Then, a filtering and draining step is performed on the polyester fabric that has undergone the degumming and decolorizing operation.

(3) Drying Operation

The polyester fabric that has undergone the degumming and decolorizing operation is dried, in which a drying temperature is 120° C., and a drying time is 2 to 4 hours.

### Comparative Example

Comparative Example involves the decolorizing step of polyester fabric attached with a gum-film or a surface treating agent and a dye.

(1) Decolorizing Operation

Sodium dithionite is mixed with water to prepare a reduction decolorization solution with a concentration of 0.5 to 15 g/L. Next, 10 grams of polyester fabric is added for the reduction decolorization reaction, in which the reaction temperature is 90 to 140° C., and the reaction time is 5 to 60 minutes. Then, a filtering and draining step is performed on the polyester fabric that has undergone the reduction decolorization reaction.

Next, an ammonium persulfate aqueous solution with a concentration of 0.5 to 15 g/L is added for the oxidation decolorization reaction, in which the reaction temperature is 60 to 120° C., and the reaction time is 5 to 60 minutes. Then, a filtering and draining step is performed on the polyester fabric that has undergone the decolorizing operation.

(3) Drying Operation

The polyester fabric that has undergone the decolorizing operation is dried, in which a drying temperature is 120° C., and a drying time is 2 to 4 hours.

### Decolorization Effect Evaluation

The polyester fabrics before treatment and the polyester fabrics after the decolorization treatment in Examples 1 to 12 and Comparative Example were subjected to optical testing.

The L*a*b color system (adopting the JIS Z8729 method) is measured with a colorimeter. The higher the L value, the whiter the hue, the higher the a value, the redder the hue, and the higher b value, the yellower the hue. The measurement results are shown in Table 1.

TABLE 1

| | | Alkaline | | | | | | |
|---|---|---|---|---|---|---|---|---|
| | Gum-film | aqueous | | Reducing | | | | |
| Sample | type* | solution | Catalyst | agent | Oxidant | L | a | b |
| Example 1 | A | NaOH | Tetrabutylammonium | Sodium | Ammonium | 90.2 | −0.2 | 5.2 |
| | | | bromide | dithionite | persulfate | | | |
| Example 2 | B | NaOH | Tetrabutylammonium | Sodium | Ammonium | 92.3 | 0.1 | 5.3 |
| | | | bromide | dithionite | persulfate | | | |
| Example 3 | C | NaOH | Tetrabutylammonium | Sodium | Ammonium | 91.5 | 0.3 | 6.2 |
| | | | bromide | dithionite | persulfate | | | |
| Example 4 | D | NaOH | Tetrabutylammonium | Sodium | Ammonium | 90.3 | −0.3 | 4.5 |
| | | | bromide | dithionite | persulfate | | | |
| Example 5 | E | NaOH | Tetrabutylammonium | Sodium | Ammonium | 91.6 | 0.2 | 3.6 |
| | | | bromide | dithionite | persulfate | | | |
| Example 6 | F | NaOH | Tetrabutylammonium | Sodium | Ammonium | 92.2 | 0.4 | 4.8 |
| | | | bromide | dithionite | persulfate | | | |
| Example 7 | A | NaOH | Tetrabutylammonium | Sodium | Ammonium | 91.5 | 0.3 | 5.5 |
| | | | chloride | dithionite | persulfate | | | |
| Example 8 | A | NaOH | Tetraethylammonium | Sodium | Ammonium | 90.3 | 0.2 | 3.9 |
| | | | hydroxide | dithionite | persulfate | | | |
| Example 9 | A | NaOH | Butyltriphenylphosphonium | Sodium | Ammonium | 91.8 | −0.5 | 4.3 |
| | | | bromide | dithionite | persulfate | | | |
| Example 10 | A | NaOH | Benzyltriphenylphosphonium | Sodium | Ammonium | 90.6 | −0.3 | 4.7 |
| | | | chloride | dithionite | persulfate | | | |
| Example 11 | A | NaOH | 18-crown-6 | Sodium | Ammonium | 90.5 | −0.8 | 5.3 |
| | | | | dithionite | persulfate | | | |
| Example 12 | A | NaOH | 12-crown-4 | Sodium | Ammonium | 92.5 | 0.6 | 5.8 |
| | | | | dithionite | persulfate | | | |
| Comparative | A | NaOH | — | Sodium | Ammonium | 75.2 | 3.5 | 20.5 |
| Example | | | | dithionite | persulfate | | | |

*A: PU gum; B: TPU gum; C: TPEE film; D: acrylic gum; E: fluorine-free water-repellent agent (3M PM-3705); F: fluorine-containing water-repellent agent (Daikin UNIDYNE TG-6071)

According to the results of Comparative Example and Example 1, it may be seen that compared to the Comparative Example in which the polyester fabric is directly decolorized, Example 1 of the disclosure in which the polyester fabric is degummed before decolorization may achieve a better decolorization effect during the decolorizing operation. According to the results of Examples 1 to 6, it may be seen that the degumming treatment of the disclosure may be applied to various types of gum-films or surface treatment agents, such as PU gum, TPU gum, acrylic gum, TPEE film, fluorine-free water-repellent agent, and fluorine-containing water-repellent agent, etc. In addition, according to the results of Examples 1 and 7 to 12, it may be seen that various catalysts (e.g., tetrabutylammonium bromide, tetrabutylammonium chloride, tetraethylammonium hydroxide, butyltriphenylphosphonium bromide, benzyltriphenylphosphonium chloride, 18-crown-6, and 12-crown-4) may all be used in the degumming operation of the disclosure, and they all facilitate in improving the decolorization effect of subsequent decolorization treatment.

To sum up, in the method for degumming and decolorizing of polyester fabric of the disclosure, after stripping various types of gum-films or treatment agents on the surface of a polyester fabric by using a combined formulation of an alkaline aqueous solution and a catalyst, then the polyester fabric is decolorized by a combination of a chemical reduction method and a chemical oxidation method. In this way, the surface treatment agent or the backside film material and the dye on the polyester fabric material may be effectively removed. In addition, compared with the solvent extraction method using organic solvents, the disclosure performs gum removal and decolorization on the polyester fabric through an aqueous solution (i.e., catalyst alkaline aqueous solution, reduction decolorization solution, oxidation decolorization solution), which is obviously more environmentally friendly.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A method for degumming and decolorizing a polyester fabric, comprising:
providing a first polyester fabric attached with a dye and a gum-film or a surface treatment agent;
performing degumming operation, comprising:
mixing a catalyst in an alkaline aqueous solution to prepare a catalyst solution; and
immersing the first polyester fabric into the catalyst solution to remove the gum-film or the surface treatment agent, and obtaining a second polyester fabric attached with the dye; and
performing decolorizing operation, comprising:
providing a reduction decolorization solution and an oxidation decolorization solution;
immersing the second polyester fabric into the reduction decolorization solution for a reduction decolorization reaction;
immersing the second polyester fabric into the oxidation decolorization solution for a oxidation decolorization reaction; and
removing the dye and obtaining a third polyester fabric.

2. The method for degumming and decolorizing according to claim 1, wherein the gum-film is selected from at least one of polyurethane gum-film, thermoplastic polyurethane gum-film, thermoplastic polyether ester elastomer gum-film, and acrylic gum, and the surface treatment agent is selected from at least one of a fluorine-containing water-repellent agent and a fluorine-free water-repellent agent.

3. The method for degumming and decolorizing according to claim 1, wherein the alkaline aqueous solution comprises at least one selected from an alkali metal hydroxide solution, an alkaline earth metal hydroxide solution, an alkaline earth metal carbonate solution, and an alkaline earth metal bicarbonate solution.

4. The method for degumming and decolorizing according to claim 1, wherein the catalyst comprises at least one selected from a quaternary ammonium salt, a quaternary ammonium base, a quaternary phosphonium salt, and a crown ether.

5. The method for degumming and decolorizing according to claim 4, wherein the quaternary ammonium salt comprises at least one selected from benzyltributylammonium chloride, benzyltriethylammonium chloride, tetrabutylammonium bromide, tetrabutylammonium chloride, tetrabutylammonium hydrogen sulfate, tricaprylmethylammonium chloride, dodecyltrimethylammonium chloride, tetradecyl, and trimethylammonium chloride.

6. The method for degumming and decolorizing according to claim 4, wherein the quaternary ammonium base comprises at least one selected from phenyltrimethylammonium hydroxide, benzyltriethylammonium hydroxide, benzyltrimethylammonium hydroxide, triethylmethylammonium hydroxide, tetramethylammonium hydroxide, tetraethylammonium hydroxide, tetrapropylammonium hydroxide, and tetrabutylammonium hydroxide.

7. The method for degumming and decolorizing according to claim 4, wherein the quaternary phosphonium salt comprises at least one selected from butyltriphenylphosphonium bromide, ethyltriphenylphosphonium acetate, ethyltriphenylphosphonium iodide, ethyltriphenylphosphonium bromide, and benzyltriphenylphosphonium chloride.

8. The method for degumming and decolorizing according to claim 4, wherein the crown ether comprises at least one selected from 12-crown-4, 15-crown-5, 18-crown-6, dibenzo-18-crown-6, and diaza-18-crown-6.

9. The method for degumming and decolorizing according to claim 1, wherein a concentration of the catalyst solution is 0.5 to 20 g/L, and a weight ratio of the catalyst solution to the first polyester fabric is 5:1 to 50:1.

10. The method for degumming and decolorizing according to claim 1, wherein a reaction condition for removing the gum-film or the surface treatment agent is: a reaction temperature of 60 to 140° C., and a reaction time of 5 to 60 minutes.

11. The method for degumming and decolorizing according to claim 1, wherein the reduction decolorization solution comprises a reducing agent and water, and the reducing agent is at least one selected from ammonium dodecylpoly (oxyethylene) sulfate, sodium dithionite, sodium thiosulfate, sodium hydroxymethanesulfinate, and thiourea dioxide.

12. The method for degumming and decolorizing according to claim 1, wherein a concentration of the reduction decolorization solution is 0.5 to 15 g/L, and a weight ratio of the reduction decolorization solution to the second polyester fabric is 5:1 to 50:1.

13. The method for degumming and decolorizing according to claim 1, wherein a condition for the reduction decolorization reaction is: a reaction temperature is 90 to 140° C., and a reaction time is 5 to 60 minutes.

14. The method for degumming and decolorizing according to claim 1, wherein the oxidation decolorization solution comprises an oxidant and water, and the oxidant is at least one selected from hydrogen peroxide, sodium nitrate, sodium nitrite, sodium chlorite, calcium chlorite, sodium hypochlorite, calcium hypochlorite, ammonium persulfate, and sodium persulfate.

15. The method for degumming and decolorizing according to claim 1, wherein a concentration of the oxidation decolorization solution is 0.5 to 15 g/L, and a weight ratio of the oxidation decolorization solution to the second polyester fabric is 5:1 to 50:1.

16. The method for degumming and decolorizing according to claim 1, wherein a condition for the oxidation decolorization reaction is: a reaction temperature is 60 to 120° C., and a reaction time is 5 to 60 minutes.

17. The method for degumming and decolorizing according to claim 1, wherein a sequence of the decolorizing operation is: the reduction decolorization reaction is performed firstly on the second polyester fabric, and then the oxidation decolorization reaction is performed on the second polyester fabric that has undergone the reduction decolorization reaction.

18. The method for degumming and decolorizing according to claim 1, wherein a sequence of the decolorizing operation is: the oxidation decolorization reaction is performed firstly on the second polyester fabric, and then the reduction decolorization reaction is performed on the second polyester fabric that has undergone the oxidation decolorization reaction.

19. The method for degumming and decolorizing according to claim 1, further comprising:
performing a drying operation on the third polyester fabric, wherein a condition for the drying operation is: a drying temperature is 120° C., and a drying time is 2 to 4 hours.
